(19) United States
(12) Patent Application Publication
(10) Pub. No.: US 2007/0140182 A1
(43) Pub. Date: Jun. 21, 2007

(54) Network information access system control method

(75) Inventor: I-Ru Liu, Taipei City (TW)

Correspondence Address: BIRCH STEWART KOLASCH & BIRCH, PO BOX 747, FALLS CHURCH, VA, 22040-0747, US

(73) Assignee: ACCTON TECHNOLOGY CORPORATION

(21) Appl. No.: 11/300,447

(22) Filed: Dec. 15, 2005

(51) Int. Cl. H04Q 7/24

(52) U.S. Cl. 370/338

(57) ABSTRACT

A network information access system control method is cooperated with a track, at least an access point (AP) and a server. In this case, the access point is connected to the track. Additionally, the access point has a driving unit and a rolling unit. First step of the method is measuring at least one monitoring signal parameter by the access point. Then, the access point is to transform the monitoring signal parameter into a loading status parameter. Then, the method is inputting a default parameter into the access point. After that, the access point is comparing the loading status with the default parameter and generating a loading status signal. Finally, the access point is transmitting the loading status signal to the server so as to the server can control the access point moved along the track.

### BACKGROUND OF THE INVENTION

The invention relates to a network information access system control method and, in particular, to a movable network information access system control method.

### RELATED ART

Recently, the rapidly developed network technique not only speeds the transmission of various information around the world but also makes our life more plentiful. People can forward e-mails, transmit data files, view Bulletin Board System (BBS), or remotely access systems through the network. This may influence the work style of governments and enterprises, and vary our life.

An electrical device or an electrical apparatus uses a network line to connect to a conventional wired access point for accessing the network resources. In this case, the arrangement of the network line may trouble the user, and the user may not use the network resources with the fixed network line when he or she is moving.

Accompanying with the development of wireless technology, some manufacturers disclosed the access point (AP) to reduce the peripheral lines. Therefore, the electrical device or the electrical apparatus can access the network resources when it is arbitrarily moved.

However, the conventional access point usually has a fixed arrangement. In more detailed, if a access point is provided in an office, the user may use the network resources within the area covered by the signal of the access point. However, if the user leaves this area, the network resources are no longer available. In addition, if the number of the users exceeds what the access point can support, some users may not access the network resources successfully.

It is therefore an important subject of the invention to provide a network information access system for the user to access the network at arbitrarily position such as the supermarket, the department store, the basketball court or the baseball field in cooperation with the developed wireless fidelity (Wi-Fi) technology.

### SUMMARY OF THE INVENTION

In view of the foregoing, the invention is to provide a movable network information access system control method.

To achieve the above, a network information access system control method of the invention cooperating with a track, at least an access point (AP), and a server. In the invention, the access point is connected to the track. In addition, the access point has a driving unit and a rolling unit. First step of the method is measuring at least one monitoring signal parameter by the access point. Then, the access point is to transform the monitoring signal parameter into a loading status parameter. Then, the method is inputting a default parameter into the access point. After that, the access point is comparing the loading status with the default parameter and generating a loading status signal. Finally, the access point is transmitting the loading status signal to the server so as to the server can control the access point moved along the track.

As mentioned above, the network information access system control method of the invention connects the access point to the track, which may be disposed at the department store or the building in accordance with the practice design. Thus, the server can control the access point to move along the track and to configure the loading status of the access point in accordance with the loading status of the access point, and as a result, the requirements of the user for arbitrarily using the network resources can be satisfied.

### BRIEF DESCRIPTION OF THE DRAWINGS

The invention will become more fully understood from the detailed description given herein below illustration only, and thus is not limitative of the present invention, and wherein:

FIG. 1 is a schematic diagram showing a network information access system cooperated with a net work information access method according to an embodiment of the invention;

FIG. 2 is a flow chart showing a network information access system control method according to the embodiment of the invention;

FIG. 3A and FIG. 3B are schematic diagrams showing the configuration of the network information access system cooperated with the net work information access method according to the embodiment of the invention, wherein FIG. 3A shows the access point disposed on a linear track, and FIG. 3B shows the access point disposed on a loop track; and

FIG. 4A and FIG. 4B are schematic diagrams showing the different configurations of the network information access system cooperated with the network information access method according to the embodiment of the invention;

FIG. 5 is a schematic diagram showing the operating status of the access points according to the embodiment of the invention;

FIG. 6A is a configuration diagram showing the network information access system with sleep mode access points located on the linear track according to the embodiment of the invention;

FIG. 6A is a configuration diagram showing the network information access system with sleep mode access points located on the loop track according to the embodiment of the invention; and

FIG. 7 is a flow chart showing a control flow of the network information access method according to the embodiment of the invention.

### DETAILED DESCRIPTION OF THE INVENTION

The present invention will be apparent from the following detailed description, which proceeds with reference to the accompanying drawings, wherein the same references relate to the same elements.

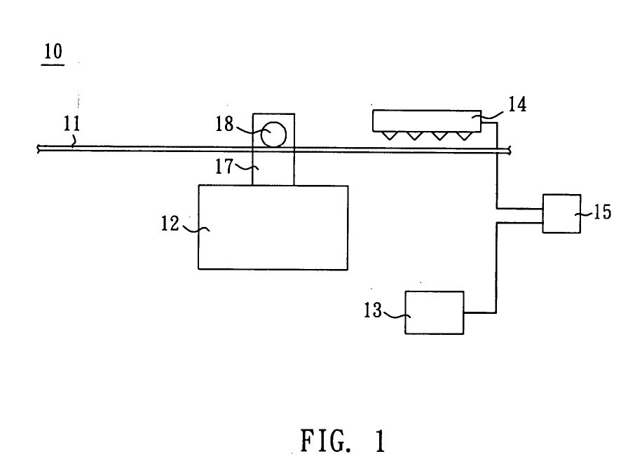

Referring to FIG. 1, a network information access system 10, which is cooperated with a network information access system control method according to a preferred embodiment of the invention, includes a track 11, at least a access point 12, a server 13, at least a sensor 14, a power supply 15, a driving unit 17, and a rolling unit 18 so as to the access point 12 connects with the track 11. In this embodiment, the driving unit 17 is connected to the access point 12 and the rolling unit 18 is connected to the driving unit 17 and the track 11, respectively. In addition, the sensor 14 is located adjacent to the track 11. The power supply 15 generates at least one power source for the network information access system. In the embodiment, the power supply 15 generates the power sources for the access point 12, the server 13, and the sensor 14, respectively. Additionally, the power supply 15 also may generate the power sources for the access point 12 and the sensor 14 through the track 11. Therefore, the wire arrangement of the network information access system can be simplified.

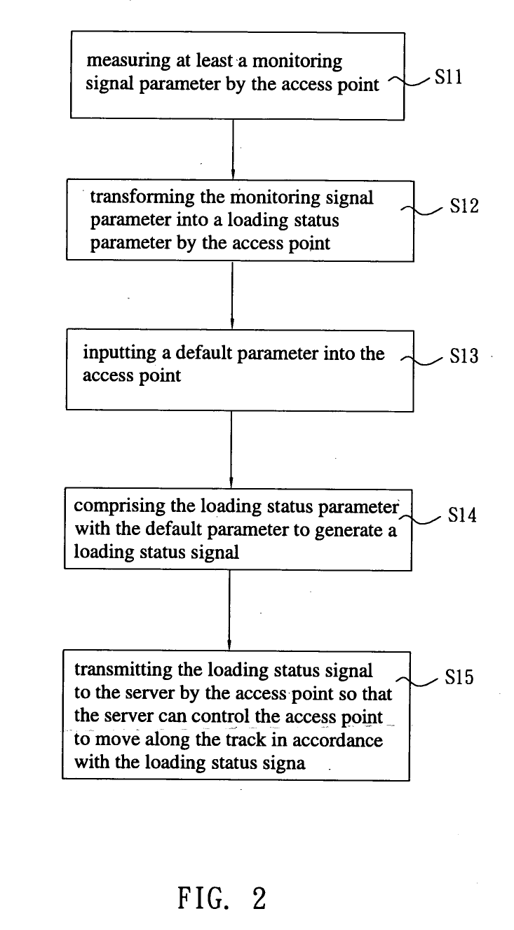

As following, cooperating with FIG. 2, the network information access system control method of the invention includes the following steps.

The step S11 is to measure at least one monitoring signal parameter that a signal coverage of the access point 12. In the embodiment, the monitoring signal parameter comprises a signal quality parameter, a link quality parameter, or a quality of service parameter.

The step S12 is to transform the monitoring signal parameter that the access point measured into a loading status parameter.

The step S13 is to input a default parameter to the access point 12 by a user or the server 13. In this case, the default parameter can be auto-set with the manufactory default by the server 13, certainly, the default parameter also can be set with manual by the user. In the embodiment, the default parameter comprises a loading distribution parameter, a peak signal parameter, a priority parameter, or a response timing parameter which represents a distribution of the load is average or not, a condition of peak load is being at one of the area or not, a high service priority user is in the area or not, or a response time of the system demanded, respectively so as to the network information access system can be applied with the various conditions or occasions.

The step S14 is to compare the loading status parameter with the default parameter by the access point 12 and the access point 12 is to generate a loading status signal. In this case, the loading status signal represents the loading status with the signal coverage og the access point 12 is a heavy loading status, a normal loading status, or a light loading status.

The step S15 is to transmit the loading status signal to the server 13 so that the server 13 can control the access point 12 to move along the track 11 in accordance with the loading status signal. In the embodiment, the server 13 controls the access point 12 to move along the track 11 by means of a wireless transmission.

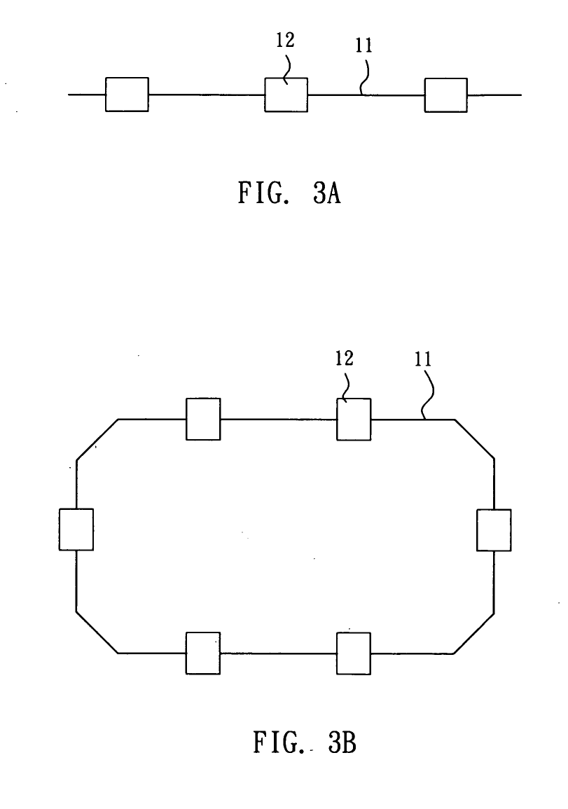

In the embodiment, a plurality of access points 12 can be disposed on the track 11, wherein each service set identifier (SSID) of the access points are the same. In addition, each of the access points 12 can be operated at different frequencies, it is meaning, at least one of the access points 12 is operated at a first frequency and another one of the access points 12 is operated at a second frequency to apply in various international standards such as IEEE 802.11a, 802.11b, 802.11g, or 802.15. Furthermore, the track 11 can be varied according to practical demands for various occasions. Referring to FIG. 3A to FIG. 3C showing the configurations of the track 11 and access points 12, the track 11 may be a linear track (as shown in FIG. 3A) or a loop track (as shown in FIG. 3B). In a normal condition, the server 13 controls the access points 12 on the track 11 with average distribution.

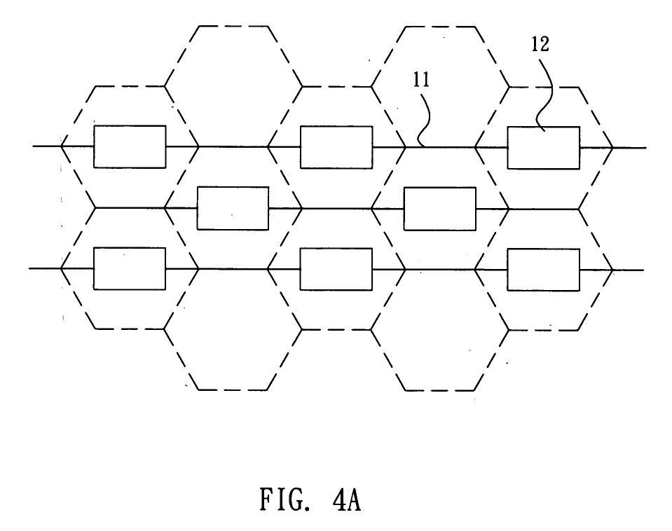

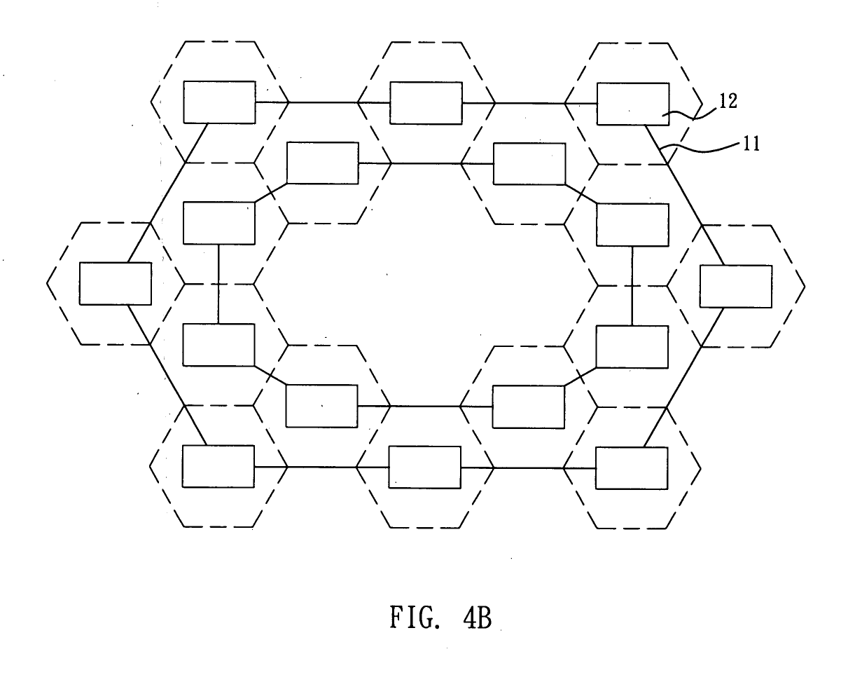

Referring to FIG. 4A and FIG. 4B, when the network information access system 10 has a plurality of linear tracks or loop tracks, the access points 12 disposed on the track 11 are in a honeycombed arrangement for providing a better signal covering range.

In the embodiment, the server 13 controls at least one of the access points 12 to provide a bipolar bias to the driving unit 17 for driving the rolling unit 18, so that the access point 12 can be moved along the track 11. The bipolar bias can be a positive bias or a negative bias. The server 13 controls the access point 12 to provide the positive bias or the negative bias to the driving unit 17 for controlling the direction of the rolling unit 18, so that the moving direction of the access point 12 on the track 11 can be changed. In addition, the driving unit 17 can also brake the access point 12 when the access point 12 generates the bipolar bias controlled properly by the server 13.

To make the invention more comprehensive, the network information access method cooperated with the network information access system 10 having a plurality of access points 12 dispose on the track 11 will be described hereinafter.

The server 13 obtains the position of each of the access points 12 on the track 11 and moves each of the access points 12 to the correct position by the sensor 14 adjacent to the track 11. The sensor 14 can be a contact sensor or a proximity sensor. In the embodiment, the sensor 14 delivers a signal to the server 13 as the access point 12 pass through the sensor 14, and then the server 13 can monitor and control the position of the access point 12 in accordance with the signal.

Furthermore, the server 13 can control the operating statuses or the signal powers of the access points 12 in accordance with the loading status signal. In the embodiment, the signal power may be a signal receiving power or a signal delivering power.

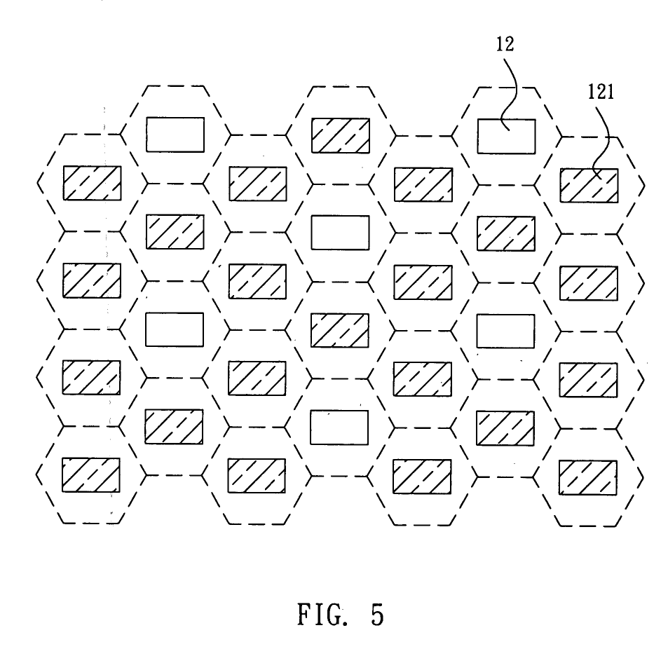

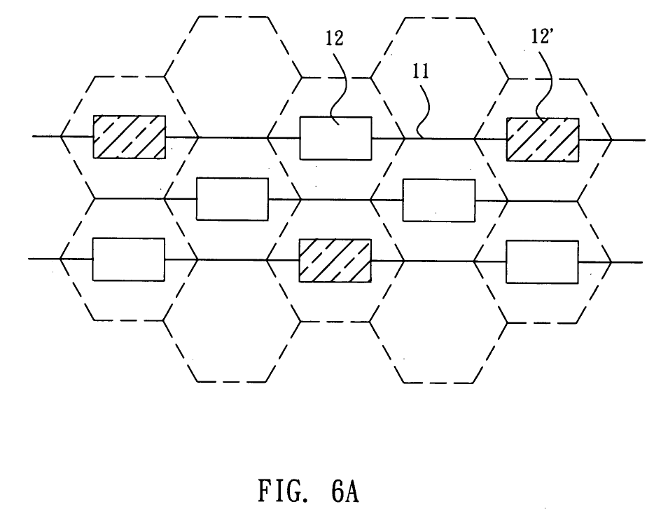

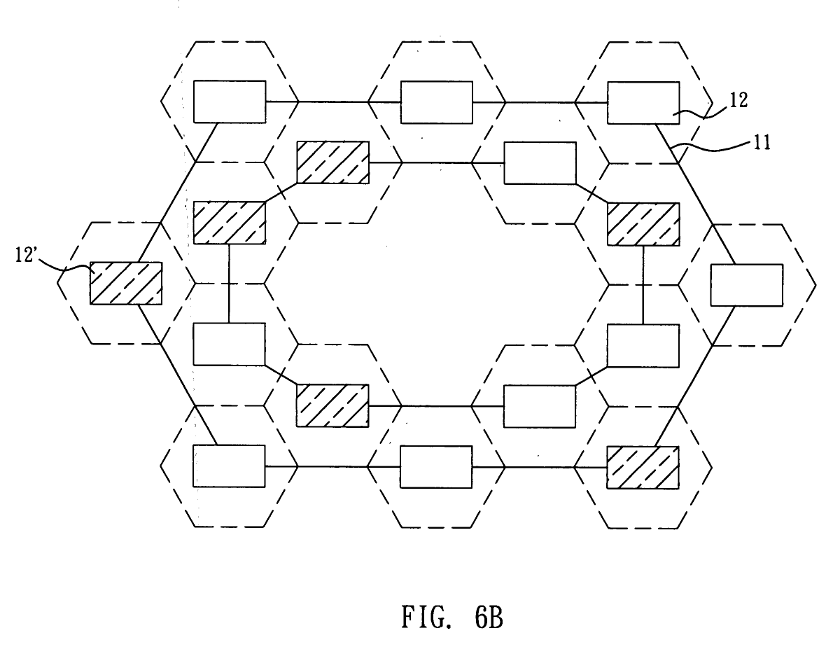

Referring to FIG. 5, for reducing the power consumption, the operating status of at least one of the access points 12′ can be controlled to be a sleep mode by the server 13. And then, the configuration of the network information access system with sleep mode access points located on the linear track or the loop track are illustrated as FIG. 6A and FIG. 6B. In this case, the server 13 can set the operating statuses of some access points 12 to be the sleep mode or reduce the signal power when the number of the users is few. In addition, the server 13 also can control the operating frequencies or channels of each access points 12 or 121 to apply with more condition. Thus, the power consumption can be efficiently reduced. Certainly, in some case, the server 13 can control some access points 12 to move to an area with a high user density or to enhance the signal powers of the access points 12 in the area with the high user density in accordance with a practice condition. Thus, all users in the area with the high user density can use the network resources.

More details, the network information access system 10 of the invention utilizes the server 13 to check the loading status of each access points in accordance with the loading status signal such as the high loading status, the low loading status, or the normal loading status for representing the corresponding user density, such as a high user density, a low user density or a normal user density, within the area where each access point 12 is located.

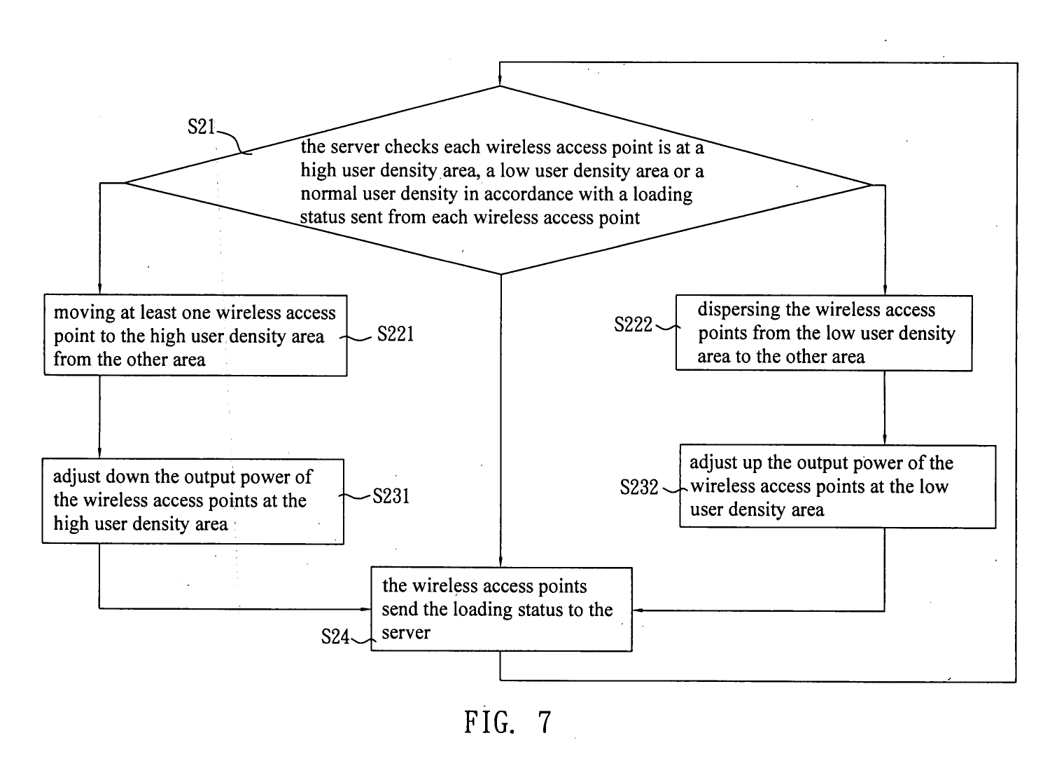

Referring to FIG. 7, which is a controlling flow chart according to the embodiment of the invention. In the procedure S21, the server 13 checks each access point 12 is located at a high user density area, a low user density area or a normal user density in accordance with a loading status sent from each access point 12. If the access point 12 works at the high user density area, the procedure S221 is then performed. If the access point 12 works at the low user density area, the procedure S222 is then performed. If the access point 12 works at the normal user density area, the procedure S23 is then performed.

In the procedure S221, the server 13 drives at least one access point 12 to move from other area to the high user density area, so that the loading of the access points 12 located in the high user density area can be shared and thus reduced.

In the procedure S231, the server 13 adjusts down the output power of the access points 12 located in the high user density area for adjusting the loading status of each access point 12. Alternatively, the server 13 can activate access points 12 of the sleep mode to adjust the loading status of each access point 12.

In the procedure S222, the server 13 drives the access points 12 to move from the low user density area to other area.

In the procedure S232, the server 13 adjust up the output power of the access points 12 located in the low user density area for adjusting the loading status of each access point 12. Alternatively, the server 13 can control the operating status of a part of the access points 12 to be the sleep mode for adjusting the loading status of each access point 12.

In the procedure S24, each of the access points 12 sends its loading status to the server 13, so that the server 13 can control the configurations of the access points 12 moving along the track 11.

In summary, the network information access system control method of the invention disposes the access point on the track and uses the server to control the movement of the access point, so that the access point can move along the track to a suitable position in accordance with the positions and the density of users. Thus, the requirements of the user for arbitrarily using the network resources can be satisfied. In addition, the operating statuses of the unnecessary access points can be set as the sleep mode to reduce the power consumption. Therefore, the network information access system can be successfully applied in Wi-Fi, so that the user can arbitrarily use network resources at the place of the department store, the gym, and the likes.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A network information access system control method cooperating with a track, at least an access point, and a server connected with the access point, wherein the access point has a driving unit and a rolling unit, the control method comprising:
measuring at least a monitoring signal parameter by the access point;
transforming the monitoring signal parameter into a loading status parameter by the access point;
inputting a default parameter into the access point;
comprising the loading status parameter with the default parameter to generate a loading status signal; and
transmitting the loading status signal to the server by the access point so that the server can control the access point to move along the track in accordance with the loading status signal.

2. The control method according to claim 1, wherein the monitoring signal parameter comprising a signal quality parameter, a link quality parameter, or a quality of service parameter.

3. The control method according to claim 1, wherein the default parameter is set by a user or the server.

4. The control method according to claim 1, wherein the default parameter comprising a loading distribution parameter, a peak signal parameter, a priority parameter, or a response timing parameter.

5. The control method according to claim 1, wherein the server controls a signal power of the access point in accordance with the loading status signal.

6. The control method according to claim 5, wherein the signal power is a signal receiving power or a signal delivering power.

7. The control method according to claim 1, wherein the server controls the access point to generate a bipolar bias for the driving unit to drive the rolling unit so as to move the access point along the track.

8. The control method according to claim 1, further comprising:
disposing at least a sensor adjacent to the track.

9. The control method according to claim 8, wherein the server obtains a position of the access point on the track by the sensor.

10. The control method according to claim 9, wherein the server obtains a position of the access point on the track by a contact sensor or an proximity sensor.

11. The control method according to claim 1, wherein the network information access system further comprises a power supply, and the power supply generates at least a power source for the network information access system.

12. The control method according to claim 1, wherein the server further controls an operating status of the access point in accordance with the loading status signal.

13. The control method according to claim 12, wherein the server controls the operating status of the access point is a sleep mode.

14. The control method according to claim 1, wherein the server controls the access point moving along a linear track or a loop track.

15. The control method according to claim 1, wherein the server controls the access point by means of a wireless transmission.

16. The control method according to claim 1, wherein at least one of the access points is operated at a first frequency and another one of the access points is operated at a second frequency when the network information access system comprises a plurality of access points.

17. The control method according to claim 16, wherein the server controls a part of the access points moving to an area with a high user density in accordance with the loading status signal.

18. The control method according to claim 16, wherein the server controls the access points on the track with average distribution in accordance with the loading status signal.

19. The control method according to claim 16, wherein each service set identifier of the access points are the same.
